(19) United States
(12) Patent Application Publication
(10) Pub. No.: US 2023/0075116 A1
(43) Pub. Date: Mar. 9, 2023

(54) SYSTEMS, DEVICES, AND METHODS FOR MATCHING PARTIES

(71) Applicants: Baldo Baldassare Minaudo, Toronto (CA); Brian David Miklas, Toronto (CA)

(72) Inventors: Baldo Baldassare Minaudo, Toronto (CA); Rajeev Verma, Jakarta (ID)

(21) Appl. No.: 17/896,338

(22) Filed: Aug. 26, 2022

Related U.S. Application Data
(60) Provisional application No. 63/237,938, filed on Aug. 27, 2021.

(51) Int. Cl. G06N 7/00; G06K 9/62; G06N 5/02; G06N 3/02

(52) U.S. Cl. CPC G06N 7/005; G06K 9/6282; G06N 5/022; G06N 3/02; G06K 9/6215

(57) ABSTRACT

Computer-implemented methods, devices, and systems for matching a requester with at least one requestee. An input representing a request from the requester is received. A top-k learning tree-based deep model is applied to at least one node embedding representing at least one requestee successively across at least one time window. Each output from each time window is concatenated with the input into a neural network input. A neural network determines each probability for the input to match each requestee. At least one requestee is presented to the requester for approval based on the probability for the input to match the requestee.

### FIELD

The present specification relates generally to artificial intelligence systems and, more particularly, to systems and methods for matching parties.

### BACKGROUND

There are several disadvantages to existing matching systems.

An initial issue is the amount of computational capacity that is generally required in order to process and find a match. This issue is further exacerbated when considering handling multiple user requests concurrently with lower computation power.

Another issue is the generality of matching results. In an effort to address the computational capacity discussed above, some matching systems resort to applying more general approaches to searches and matching. While this solution may provide reduced times for results, these results may be less accurate and may be ignored or rejected by the submitter and more often than not result in a second (or further) submission in an attempt to receive alternative results.

An additional disadvantage of the generality of matching results is the time and effort required by the searching party to sort through the results to determine which ones would best meet their needs. Specifically, this can manifest in having to sort through the results to find the appropriate results(s) or matches best equipped to help with specific criteria.

Lastly, many searches are limited to word-based results and fail to account for additional needs of the searching party, such as availability of resource, locational requirements, cultural sensitivities, budget preferences, and delivery format. These needs can be derived uniquely for each use case.

### SUMMARY

In accordance with an aspect, a computer-implemented method for matching a requester to at least one requestee, includes: receiving input representing a request from the requester; applying a learning top-k tree-based deep model to at least one input and at least one node embedding representing at least one parameter of at least one requestee successively across at least one time window; wherein, in each time window, at least one parameter processed in the time window is weighted averaged; and wherein each output from each time window for a requestee is concatenated and further concatenated with at least one corresponding node embedding as an input for a probability function, each output representing a probability of a match between a requester parameter derived from the input and a requestee parameter; determining via the probability function the probability that a requestee is preferred by the requester given the input; and presenting at least one requestee to the requester for approval based on the probability for the input to match the requestee.

In some embodiments, the method further includes using a neural network to optimize at least one node embeddings for based on at least one node based on feedback from the requester response.

In some embodiments, the method further includes generating the at least one node embedding based on at least one knowledge repository attribute associated with at least one requestee.

In some embodiments, at least one successively suitable node embedding is selected for each successive time window.

In some embodiments, wherein each successively suitable node embedding is selected based on proximity to a previously selected node embedding in a top-k tree model and a determined probability of the previously selected node embedding to match the input.

In some embodiments, the method further includes, for each time window, generating a node embedding from the top-k tree model and determining a weighted average of at least one parameter across each requestee represented in the node embedding.

In some embodiments, the method further includes determining the weighted average by applying a weight activation function to each parameter represented in the node embedding, the weight activation function based on a determined value of the requestee.

In some embodiments, the method further includes generating the input by applying named entity recognition on the request.

In some embodiments, the method further includes optimizing the top-k tree model for determining each probability.

In some embodiments, the method further includes generating one or more knowledge repository variations for at least one requestee.

In some embodiments, the input represents the request and additional elements associated with the requestee, the additional elements comprising language, interests, online behavior, historical behavior, availability, or learning style.

In some embodiments, the probability function is defined as

$${P}^{( j )} ( n \vert u ) = \frac{{max}_{{n}_{c} ∈ \{ n ' s children nodes in level j + 1 \}} {P}^{( j + 1 )} ( {n}_{c} \vert u )}{{α}^{( j )}} ,$$

wherein n is a non-leaf node in level j, u is a requestee, P^{(j)}(n|u) is the ground truth probability that user u is interested in n, and α^{(j)} is the layer-specific normalization term of level j to ensure that the probability sum in the level equals to 1.

In accordance with an aspect, a computer-implemented system for matching a requester to at least one requestee, includes: a non-transitory memory storing input representing a request from the requester; a machine learning processor configured to: apply a top-k tree model to at least one node group representing at least one parameter of at least one requestee successively across at least one time window; concatenate each output from each time window for a requestee and at least one node embedding as an input for a probability function; and determine, via the probability function, each probability for the input to match each requestee; and a user interface configured to present at least one requestee to the requester for approval based on the probability for the input to match the requestee.

In some embodiments, the machine learning processor is further configured to generate the at least one node embedding based on at least one knowledge repository attribute associated with at least one requestee.

In some embodiments, at least one successively suitable node embedding is selected for each successive time window.

In some embodiments, each successively suitable node embedding is selected based on proximity to a previously selected node embedding in the top-k tree model and a determined probability of the previously selected node embedding to match the input.

In some embodiments, the machine learning processor is further configured, for each time window, to generate a node embedding from the top-k tree model and determining a weighted average across each requestee represented in the node embedding.

In some embodiments, the machine learning processor is further configured to determine the weighted average by applying a weight activation function to each requestee represented in the node embedding, the weight activation function based on a determined value of the requestee.

In some embodiments, the system further includes an input processor configured to generate the input by applying named entity recognition on the request.

In some embodiments, the machine learning processor is further configured to optimize the top-k tree model for determining each probability.

In accordance with an aspect, a non-transitory computer-readable medium stores a set of machine-interpretable instructions which, when executed, cause a processor to perform a method for matching a requester to at least one requestee, the method comprising: receiving input representing a request from the requester; applying a learning top-k tree-based deep model to at least one input and at least one node embedding representing at least one parameter of at least one requestee successively across at least one time window; wherein, in each time window, at least one parameter processed in the time window is weighted averaged; and wherein each output from each time window for a requestee is concatenated and further concatenated with at least one corresponding node embedding as an input for a probability function, each output representing a probability that the requester prefers a parameter of the requestee; determining via the probability function the probability that a requestee is preferred by the requester given the input; and presenting at least one requestee to the requester for approval based on the probability for the input to match the requestee. In some embodiments, there is provided a computer-implemented method for matching a first party to a second party, comprising the steps of: receiving a request from the first party (requester); creating a profile for the first party, the profile comprising a combination of the request and additional elements associated with the first party, the additional elements to be configured based on use case and comprising but not limited to: language, interests, online behavior, historical behavior, cultural sensitivities, religious perspectives, level of sophistication and availability; applying a Hierarchical Top K tree model process incorporating the first party profile and extracted one or more Named-entity recognition (NER) of topic using Natural language processing (NLP) to hierarchy of nodes of second party (requestee) profiles across multiple time windows; concatenating outputs from the multiple time windows into a neural network input; determining, a probability for the requester request matched to multiple requestee profiles in order of ranking; and outputting one or more requestee profiles to the requester (first party) for approval based on the determined probability.

Other aspects and features according to the present application will become apparent to those ordinarily skilled in the art upon review of the following description of embodiments of the invention in conjunction with the accompanying figures.

### BRIEF DESCRIPTION

The principles of embodiments may better be understood with reference to the accompanying figures provided by way of illustration of an exemplary embodiment, or embodiments, incorporating principles and aspects, and in which:

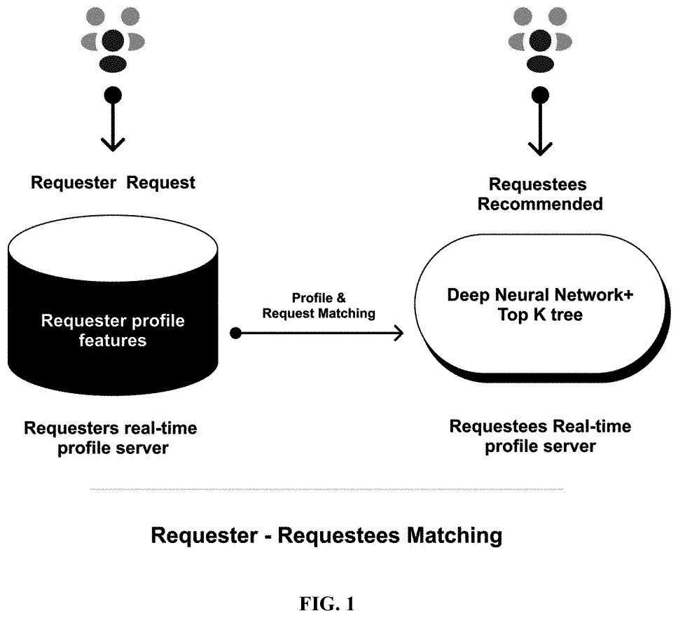

FIG. 1 is a schematic view of a matching system, according to some embodiments;

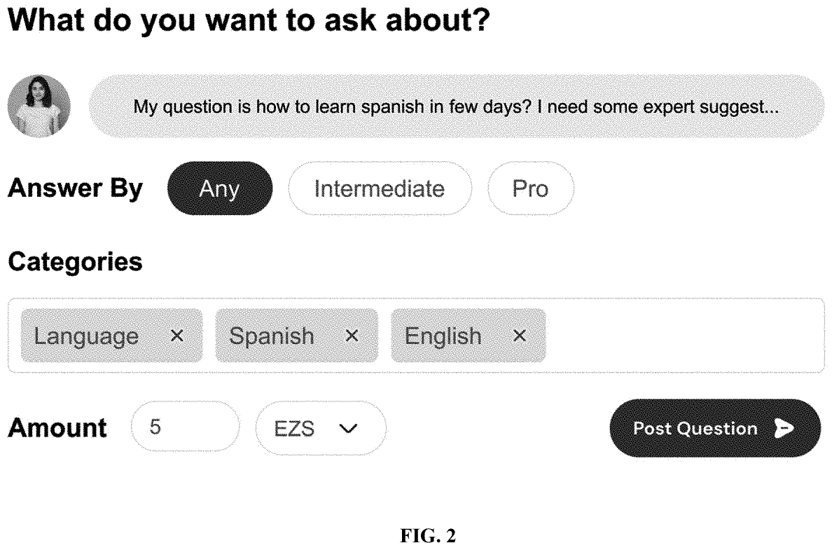

FIG. 2 is a user interface showing a requester request, according to some embodiments;

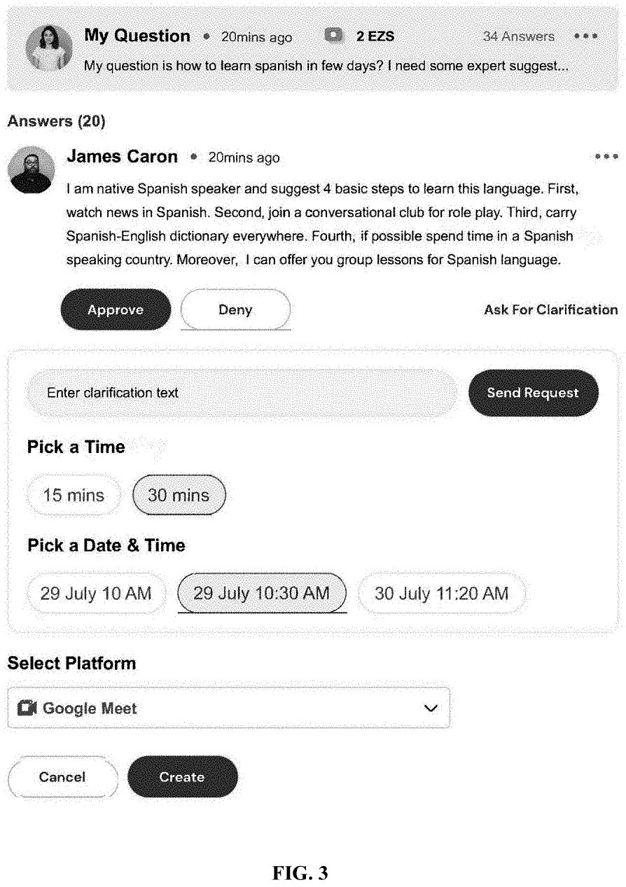

FIG. 3 is a user interface showing a match, according to some embodiments;

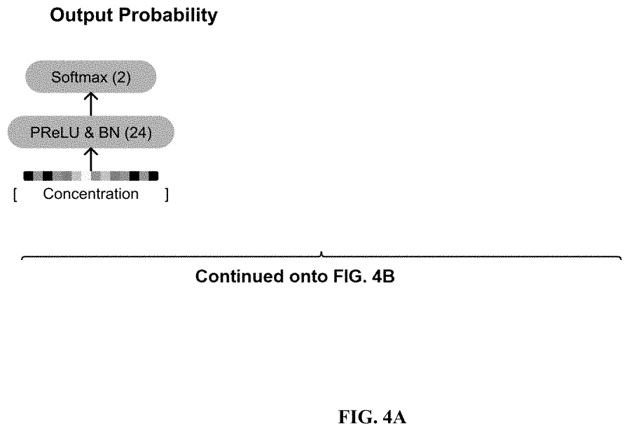

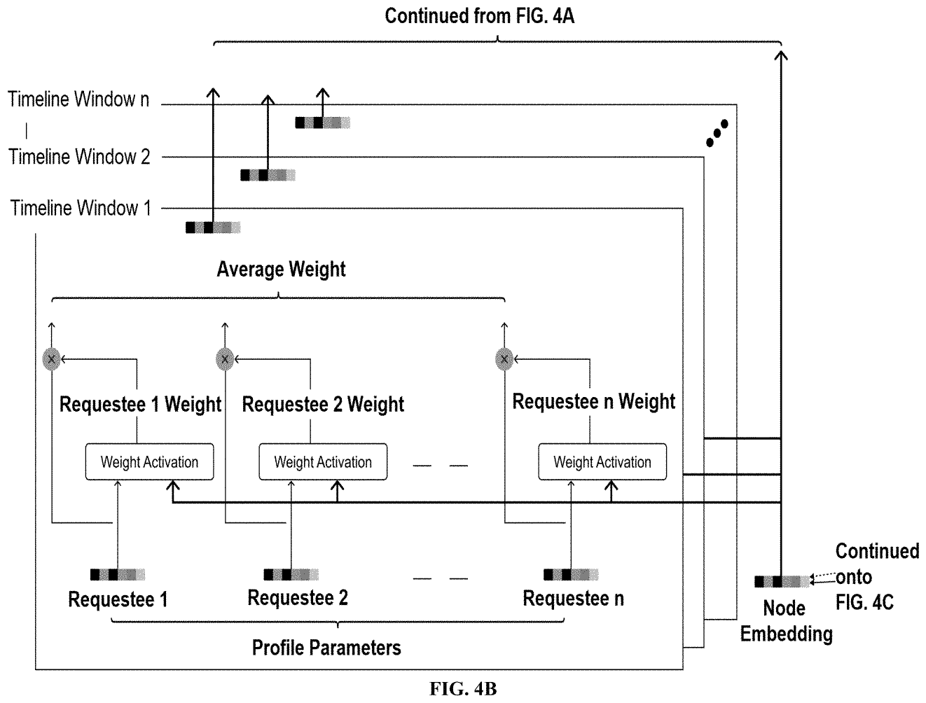

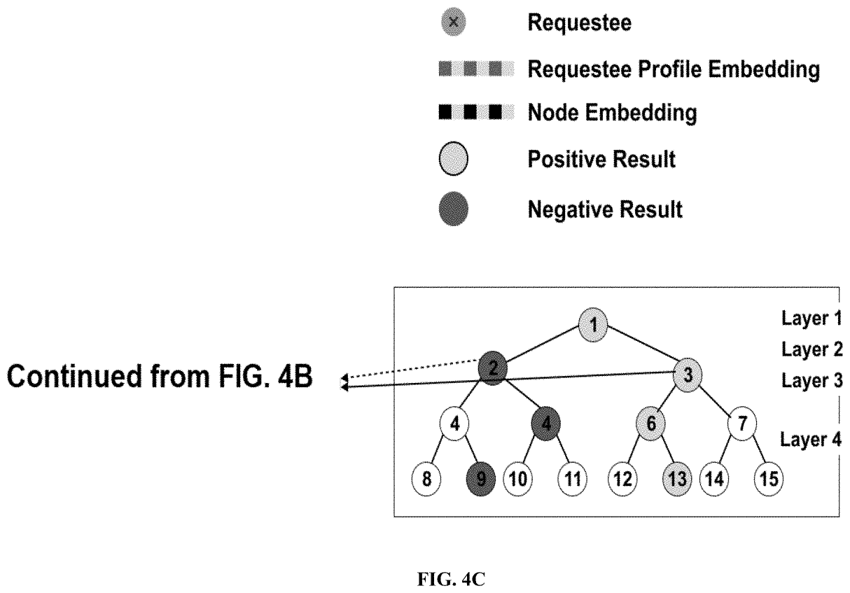

FIG. 4A is a portion of a schematic view of a matching system, according to some embodiments;

FIG. 4B is a portion of a schematic view of a matching system, according to some embodiments;

FIG. 4C is a portion of a schematic view of a matching system, according to some embodiments;

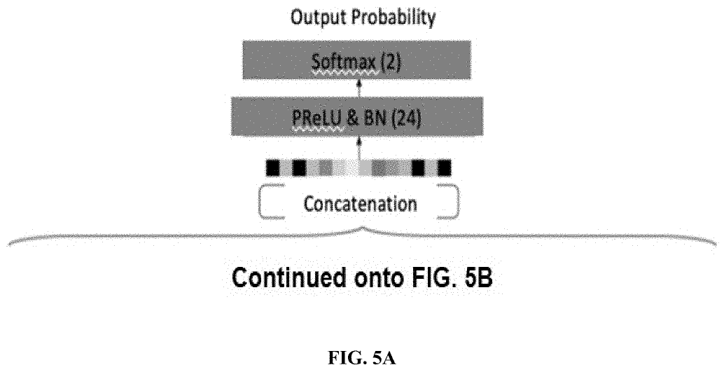

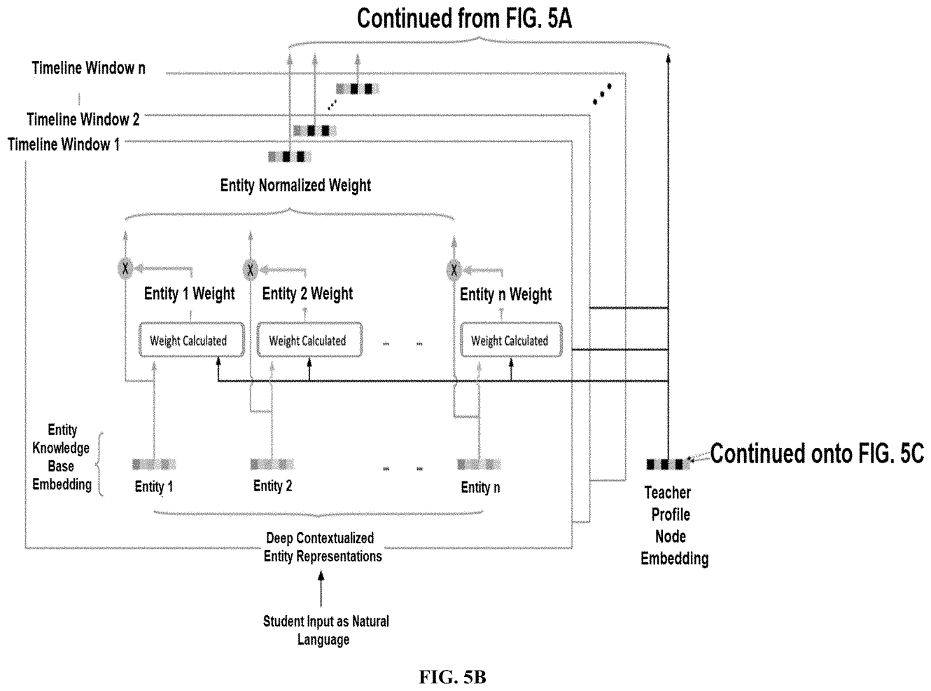

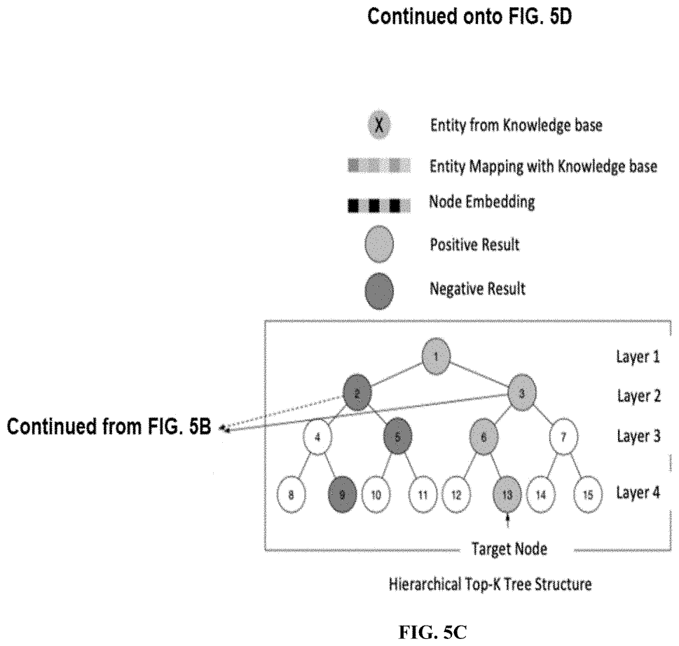

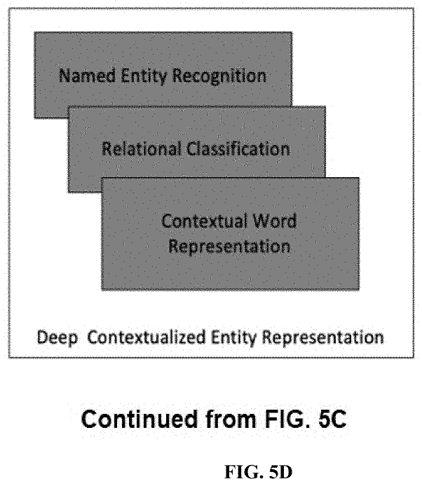

FIG. 5A is a portion of a schematic view of a matching system, according to some embodiments;

FIG. 5B is a portion of a schematic view of a matching system, according to some embodiments;

FIG. 5C is a portion of a schematic view of a matching system, according to some embodiments;

FIG. 5D is a portion of a schematic view of a matching system, according to some embodiments; and

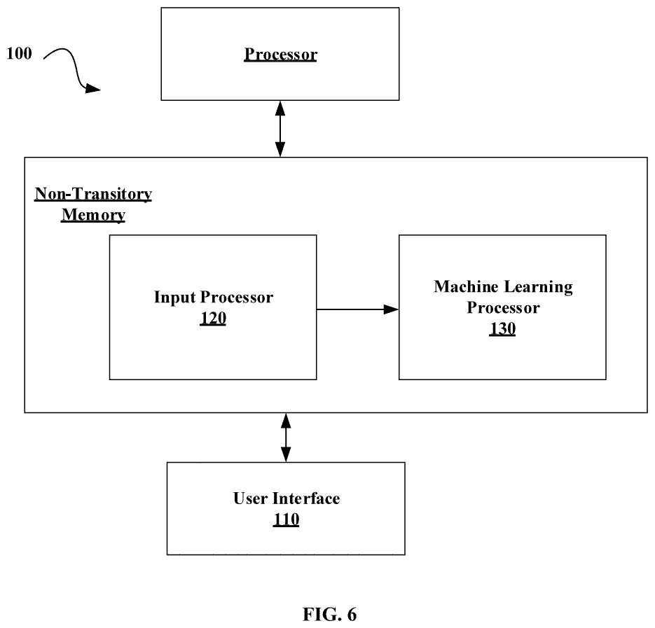

FIG. 6 is a schematic view of a matching system, according to some embodiments.

### DETAILED DESCRIPTION OF EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly to depict certain features of the invention. As described herein, a computer is a device with a display that accepts user input, including, but not limited to, a personal computer, a laptop computer, a tablet, a smartphone, a smartwatch, or an implanted digital device. In some embodiments, a computer is another device that is configurable to implement one or more embodiments contemplated herein.

In some embodiments, matching system 100 is configured for matching parties based on configurable criteria encompassing multiple use cases.

In some embodiments, matching system 100 is configured for the use case of education where students (e.g., learners) and teachers (e.g., educators) are matched. In some embodiments, matching system 100 is configured for other use cases. Matching system 100 is not limited to the use case involving matching students and teachers.

Disclosed herein are computer-implemented methods, devices, and systems for matching a requester with at least one requestee based on a request from the requester. In some embodiments, a profile is created for the requester (e.g., additional elements) and is combined with the request and the combination is subjected to a requestee node embeddings derived out of a knowledge base using hierarchical top-k tree-based model to create an input to a neural network to determine matching requestees from the available requestee profiles.

In some embodiments, matching system 100 includes one or more processing devices (e.g., processor) and one or more storage devices. As shown in FIG. 6, the processing is configured to execute instructions in non-transient memory (or equivalent storage medium) to configure user interface 110, input processor 120, and machine learning processor 130. User interface 110 comprises a device that presents audio and/or visual user interface elements.

FIG. 1 shows an example schematic view for a matching system 100, according to some embodiments. The matching system 100 implements a computer-implemented system and method for matching a requester (first party) with a requestee (second party) based on a request from the requester. Matching system 100 at input processor 120 is configured to create a profile for the requester and combine the profile with the requester's request. Machine learning processor 130 is configured to use data from same in a hierarchical top-k tree-based model along with a Deep Learning Model (such as shown in FIG. 4A to FIG. 4C). In some embodiments, other learning tree-based deep models are used. The model is configured to create an input for a neural network. The neural network is configured to then determine one or more matching requestees from the available requestee profiles. The one or more matching requestees are determined based on the requester's request by prediction using the hierarchical top-k tree-based model.

In some embodiments, requesters' requests are divided into different time windows according to the timestamp.

In each time window, item embeddings (e.g., each representing a requester's request parameter) are weighted averaged, and the weights are derived from activation units. The activation unit generates an activation weight based on node embeddings from the tree model as well as parameter of a requester's request. Each time window's output along with the candidate node's embedding are concatenated as the neural network input. After three fully connected layers with PReLU activation and batch normalization, a binary softmax is used to yield the probability whether the requester is interested in the candidate node. PReLU activation can be performed such as described in “Bing Xu, Naiyan Wang, Tianqi Chen, and Mu Li. 2015. Empirical evaluation of rectified activations in convolutional network. arXiv:1505.00853 (2015)”, and batch normalization can be performed as described in “Sergey Ioffe and Christian Szegedy. 2015. Batch normalization: Accelerating deep network training by reducing internal covariate shift. In International conference on machine learning. 448-456”, each of which are hereby incorporated by reference in its entirety, except any incorporation by reference is limited such that no subject-matter is incorporated that is contrary to the explicit disclosure herein or that would render invalid any claim herein and, in the event of any inconsistencies, the usage in the present document controls.

In some embodiments, each item and its corresponding leaf node share the same embedding. All embeddings are randomly initialized.

Input processor 120 is configured to receive and process one or more requests received by matching system 100, such as through user interface 110 from a requester and/or a requestee. For example, a requester provides a request through user interface 110. Input processor 120 is configured to determine one or more elements that are suitable for determining a match with one or more requestee profiles. FIG. 2 shows an example user interface 110 showing an example request by a requester, according to some embodiments. As used herein, parameter and item or element may be referred to interchangeably, but have the same meaning. A primary element of the request shown is the request that the requester is making (e.g., “I want to learn to speak Spanish”). Additional elements may then be provided to refine the request. These additional elements may include request-specific elements, such as a time frame for completion (e.g., days, weeks, months) and delivery format for the response (e.g., text, audio, video, interactive, and combinations thereof). Other additional elements may include personal elements (e.g., language, location, available dates and times) and commercial elements (e.g., budget, payment methods). Other additional elements can include categories or topics related to the request (e.g., language, Spanish, English, science, space, gravity, etc.), a type of requestee requested (e.g., any, intermediate, pro), and/or an amount willing to be paid. Requests can be hidden from other users (e.g., requesters or requestees), except where a user is qualified based on the request (e.g., is a teacher associated with a high probability of matching the requester request as determined by the method or model described herein). Matching system 100 is configured to implement permissions-based access to its components and functionality, for example, allowing different user types or users (e.g., based on associated criteria, profile attributes, history, interaction history, matching history) permission to view, respond to, interact with, or perform other functions.

FIG. 3 shows an example user interface 110 presented to a requester following one or more matches determined by matching system 100 at machine learning processor 130, according to some embodiments. The user interface 110 is configured to accept user input representing approval of one or more of the matches presented. In some embodiments, approval can be based on the requestee's profile and/or based on the requestee's reply (e.g., answer) to the requester's request. For example, in some embodiments, upon determining a match with a requestee, the requestee can be presented with the requester's request, and the requestee can submit a reply (e.g., answer), which is then presented to the requestee via user interface 110. In addition to the requestee profile(s) of the requestee(s) returned as a match by matching system 100, any requested additional elements may also be presented at the user interface 110. The user interface 110 is configured to accept user input from the requester and/or the requestee representing negotiation and/or agreement between the parties. For example, a time availability contained in the request provided by the requester may be presented to both parties, as well as each requestee's time availability. The requester or requestee may select or input a communication for transmission to the other party to further negotiate a suitable time. Matching system 100 is configured to transmit and present the communication to the other party. Various user interface elements presented following determination and/or presentation of one or more matched requestees include answers from one or more or each requestee, a request for clarification component (e.g., requester can enter text to send to a particular or one or more requestees), a time and/or date for an engagement, and/or a platform over which to carry out the engagement.

If a match is rejected, matching system 100 using machine learning processor 130 is configured to provide an alternative match, or the request may be re-run by the requester, according to some embodiments. In an example, in the case of a specific question provided in the request, the requestee can offer to answer the question, and the requester can agree to receive the answer. Same is communicated for transmission through the user interface 110. As used herein, requestee and teacher may be used interchangeably, and searcher and requester and learner may be used interchangeably.

In some embodiments, input processor 120 is configured to determine one or more primary elements and/or one or more additional elements from the request. For example, terms used in a request can be matched by input processor 120 to elements in a natural language dictionary data structure, according to some embodiments.

In some embodiments, at input processor 120, matching system 100 receives input, such as in a natural language form (e.g., one or two or more sentences). Input processor 120 is configured to process the input and perform entity identification from the input. Input processor 120 is configured to perform query extraction using named-entity recognition (NER) on the input and extracts one or more NER entities (e.g., values) based on natural language processing (NLP) using a knowledge repository. The knowledge repository comprises a data storage including one or more terms and one or more rules for associating NER entities. The knowledge repository is configurable to include additional data, such as new terms or rules. This can allow the NER to be improved over time. According to some embodiments, there are two main steps involved in knowledge base tree construction and learning approaches. First is tree initialization. In some embodiments, where the tree represents requester(s)' request(s)' hierarchical information, the initial tree is built using a method that leverages parameter information. Without loss of generality, a binary tree can be used as an example. Firstly, all parameters are sorted randomly and grouped by similar category. If a parameter belongs to more than one category, the parameter is assigned to a random category for uniqueness. In such a way, a list of ranked parameters is generated.

Second is tree learning. Each leaf node's embedding from the tree model can be learned after model training. The learned leaf nodes' embedding vectors are used to cluster a new tree. k-means clustering can be used for its scalability where the size of the items to be clustered is large. At each step, items are clustered into two subsets according to their embedding vectors. The two subsets can be adjusted to be equal for a more balanced tree. This method is performed recursively until only one parameter is left. Accordingly, the method is configured to construct a binary tree in a top-down way, according to some embodiments. In some embodiments, alternatively, the deep model and tree structure are learnt jointly as follows: 1) Construct an initial tree and train the model until converging; 2) Learn to generate a new tree structure using trained leaf nodes' embeddings; 3) Train the model again with the learnt new tree structure. In some embodiments, a tree based knowledge repository is generated in this manner.

Input processor 120 is configured to provide one or more NER values to machine learning processor 130. Machine learning processor 130 includes a machine learning model (e.g., as shown in FIG. 4A to FIG. 4C), which is configured to output a probability distribution of each node group comprising requestee parameters matching the requester request parameters, represented by the one or more NER entities.

FIG. 4A to FIG. 4C and FIG. 5A to FIG. 5D shows schematic views of example matching systems 100, according to some embodiments. In FIG. 4A to FIG. 4C, machine learning processor 130 is configured to implement a top-k tree structure model for grouping requestee parameters (e.g., stored and retrieved from one or more databases) based on a knowledge repository attribute, which is generated based on parameters such as expertise in an area (including on a particular topic or subtopic), years of experience, location, and language, teaching style. In other embodiments, machine learning processor 130 is configured to implement another learning tree-based deep model and same can be substituted for references to each top-k tree structure made herein.

In some embodiments, when generating a machine learning model (e.g., top-k tree structure), machine learning processor 130 is configured to generate an initial node is based on a knowledge repository parameters (e.g., knowledge base such as based on subjects, topics, sub-topics over the area of a particular education sector). For example, requestees having an associated knowledge repository representing that they have knowledge in the same sub-topic can be grouped in a node. Nodes can group requestees in this or other ways based on knowledge repositories, including a combination of attributes represented in associated knowledge repositories. In some embodiments, over time, the matching system 100 is configured to create variations of these knowledge repositories (e.g., knowledge base) to encompass a global knowledge repository. The global knowledge repository can be used as the knowledge repository. Each requestee parameters are grouped in nodes embeddings, and a global knowledge repository having multiple node embeddings can be created from each of these knowledge repositories. A knowledge repository is represented by a tree structure having multiple nodes representing requestee parameters, according to some embodiments.

Each node in the model represents a grouping of requestee parameters. As used herein, a requestee parameters can be referred to as a attributes. A requestee (e.g., teacher) profile can be represented in more than one node; each node can represent requestee profile parameters. The nodes can be stored in a cached database or retrieved from a remote server, for example. In some embodiments, other attributes can include a requestee's review scores (e.g., feedback from requesters matched with the requestee for a previous request). In some embodiments, a different top-k tree structure model can be generated by machine learning processor 130 based on the requester (e.g., other inputs), the requester's request, or one or more NER entities corresponding to an input from a requester's request, such as based on the requester's indicated preference of what attributes are significant to them. Different hierarchical top-k tree structures can be generated by machine learning processor 130. For example, different tree structures can group different sets of requestee profiles as different nodes. In some embodiments, the hierarchical top-k tree structure used can improve the ability of the matching system 100 to determine matches for a particular requester request, such as by reducing the computation time to do so by reducing the search of number of nodes embeddings required to be assessed in a timeline window and further processed by a neural network. The number of batch processes (e.g., in timeline windows) performed can be optimized.

Machine learning processor 130 is configured to generate at least one node embedding. A node embedding is generated based on one or more NER entities from the input received from the requester's request.

Requestee parameters (e.g., attributes related to the requestee) represented in a node or node embeddings are combined by machine learning processor 130 under at least one node embedding. In some embodiments, all parameters are sorted randomly, and grouped them to similar category. If a parameter belongs to more than one category, the parameter is assigned to a random one for uniqueness. In such way, a list of ranked parameters is generated. This process can be termed tree initialization. A knowledge repository includes knowledge repository attributes. A requestee profile includes their multiple knowledge repository attributes.

In some embodiments, machine learning processor 130 is configured to select a node or group of nodes from the Top K tree structure model, and the parameters represented by the node(s) are used to generate at least one node embedding, which is processed in a batch in a single timeline window. In some embodiments, the block-wise input layer is configured to distinguish parameters that lie in different time windows. The parameters can also be divided into different time windows along the timeline, and item embeddings in each time window is weighted averaged. The embeddings of tree nodes and the tree structure itself and the corresponding parameters are used to train a neural network. In particular, each requestee profile parameter is grouped in node embedding generated from a node or group of nodes in the top-k tree model, according to some embodiments.

In processing a timeline window, machine learning processor 130 is configured to generate a weighted average of all the requestee weights being processed in that timeline window. The weighted average is generated as the average of weight activation values for requestees parameters from the node embedding when mapped with requester parameters. The weighted average from each timeline window (e.g., the present timeline window and each previously processed timeline window) is concatenated with the node embedding. Machine learning processor 130 is configured to use the concatenated output as an input in neural network computation.

In some embodiments, the weight activation function is derived based on the primary and secondary profile value of the requestee, services offered related to those values on the platform, feedback received from requesters, and/or frequency of offering respective services. The weight activation function can be derived from the probability function described herein, according to some embodiments.

In some embodiments, machine learning processor 130 is configured to receive the concatenated output as an input to one or more neural networks. The neural network outputs a probability that the requester's request matches each of the requestee parameters processed in the timeline windows. In some embodiments, the neural network uses PReLU (Parametric Rectified Linear Unit) activation, a batch normalization (BN), and a softmax function, which defines a threshold value. The BN generates a normalized value for each requestee profile, and each normalized value is determined by the machine learning processor 130 as to the probability that the corresponding requestee profile (represented by the normalized value) matches the one or more NER entities from a requester's request. The threshold value is then used by the machine learning processor 130 to determine whether and which node(s) to select from the top-k tree structure for processing in a subsequent timeline window. If the probability outputted from the neural network meets or exceeds the threshold value (or is within a pre-defined relation relative to the threshold value), the machine learning processor 130 does not select any further nodes for processing. One or more requestee profiles corresponding to the highest probability outputs are selected for presentation at a user interface 110 accessible by the requester. In some embodiments, this feedback process allows for more closely matching nodes or groups of nodes to be selected and processed in successive timeline windows and, ultimately, used for determination of probabilities that each requestee profile in the nodes or groups of nodes match the request from the requester (e.g., as represented by NER entities).

In some embodiments, an advanced neural network feasible to interact Requester and Requestee parameters in large-scale recommendation is used, which opens a new perspective for recommender systems. Although advanced neural networks may use more calculation when inferring, the complexity of a whole prediction process is no larger than O (k*log|C|*t), where k is the required results size, |C| is the corpus size and t is the complexity of network's single feed-forward pass. This complexity upper bound is acceptable under current CPU/GPU hardware conditions, and user side's features are shared across different nodes in one retrieval and some calculation could be shared according to model designs in some embodiments.

As an example embodiment, in operation, as shown in FIG. 4A to FIG. 4C, a hierarchical top-k model is applied to the combination against a database of requestee parameters. A tree node structure is used with decisions made at each user node pair. The model is further refined using a deep neural network to improve the model's compatibility with the Requester requests. In some embodiments, the model leads to reduced computational requirements to reach the matches and a corresponding reduction in the time requirements.

The model outputs are processed in different time windows and within each time window, the embedded requestee profiles are subject to a weighted average using a weight activation method. Accordingly, the output from each time window is concatenated with the node's embedding (e.g., the respective node embedding used for each respective timeline window) as the input to the neural network. Each requestee profile and its corresponding leaf node share the same embedding. A PreLU (Parametric Rectified Linear Unit) activation is applied to the fully connected layers, as well as a batch normalization (BN). Once applied, a binary softmax function is applied to determine the probability that the requester would be interested in the requestee (candidate node). For example, this allows a requester's request to be matched with requestee(s) and for the latter to be presented to the former via a user interface 110. For example, the requestee associated with the highest probability as determined by the neural network can be presented or, requestees associated with the highest probabilities above a threshold can be presented.

Once a sufficient number of requestee(s) with sufficient probability are found, their requestee profile(s) are then output to the requester for approval. The sufficient probability level may be pre-defined by the system or may be set by the requester. A requester can be presented with information about each requestee having a probability of matching above a threshold value, and the requester can select one or more requestees for the request.

In various embodiments, the computer-implemented method, system, and/or device may be provided as a stand-alone software application or as an API to enable integration with existing applications.

Initial training and validation for the neural network was performed using the MovieLens 20M dataset and the Taobao UserBehaviour 1M dataset. The MovieLens 20M dataset comprises 9,939,873 records associated with 129,797 users across 20,709 items and 20 categories. The Taobao UserBehaviour 1M dataset comprises 100,020,395 records associated with 969,529 users across 4,158,142 items and 9,436 categories.

The computer-implemented method can allow requesters to crowdsource a solution to a problem specified in a request in a cost-effective and time-bound manner.

### Example Embodiment

An example system and method will now be described according to some embodiments. Input processor 120 is configured to receive input representing a request from the requester and classify same into categories using named entity recognition.

Machine learning processor 130 is configured to apply a learning top-k tree-based deep model to at least one node group representing at least one requestee successively across at least one time window. In some embodiments, the learning tree-based deep model is a top-k tree model and deep learning model.

The learning top-k tree-based deep model is constructed by machine learning processor 130 as follows. There are two main steps involved in tree construction and learning approaches.

First is tree initialization. In some embodiments, where the tree represents requester(s)' request(s)' hierarchical information, the initial tree is built using a method that leverages parameter information. Without loss of generality, a binary tree can be used as an example. Firstly, all parameters are sorted randomly and grouped by similar category. If a parameter belongs to more than one category, the parameter is assigned to a random category for uniqueness. In such a way, a list of ranked parameters is generated.

Second is tree learning. Each leaf node's embedding from the tree model can be learned after model training. The learned leaf nodes' embedding vectors are used to cluster a new tree. k-means clustering can be used for its scalability where the size of the items to be clustered is large. At each step, items are clustered into two subsets according to their embedding vectors. The two subsets can be adjusted to be equal for a more balanced tree. This method is performed recursively until only one parameter is left. Accordingly, the method is configured to construct a binary tree in a top-down way, according to some embodiments. In some embodiments, alternatively, the deep model and tree structure are learnt jointly as follows: 1) Construct an initial tree and train the model until converging; 2) Learn to generate a new tree structure using trained leaf nodes' embeddings; 3) Train the model again with the learnt new tree structure. In some embodiments, a tree based knowledge repository is generated in this manner.

Machine learning processor 130 is configured to determine via the trained neural network calculate the probability of whether a requestee is preferred given the input features (e.g., NER entities from a requester's request).

User interface 110 is configured to present at least one requestee to the requester for approval based on the probability for the input to match the requestee. One or more of the requestees presented can also submit data input or otherwise interact with the requester, such as to negotiate a time or cost. The requester can view any such interactions from each requestee and approve and/or deny one or more requestees.

### Example Embodiment

An example system and method will now be described according to some embodiments. Input processor 120 is configured to receive input representing a request from a requester and extract items (also referred to herein as parameters or knowledge repository attributes), such as learning style, location, language, and/or other items. Input processor 120 is configured to map the items to requestee(s)' corresponding parameters. For example, a requester's item such as learning style can be matched to a requestee's item such as teaching style. The mapping (e.g., association) is stored by input processor 120 and is used when subsequently instructing one or more searches of parameters in nodes, such as in the hierarchical top-k tree.

Machine learning processor 130 is configured to implement a learning top-k tree-based deep model, according to some embodiments. An example is described as follows.

Machine learning processor 130 is configured to construct a tree (e.g., hierarchical top-k tree) by performing tree initialization using layer wise retrieval rules to group parameters of multiple (e.g., all) requestees into groups (e.g., nodes). Nodes can be arranged such that child nodes are more specific than their respective parent node. For example, in some embodiments, all parameters from all requestees are grouped and arranged into nodes of the tree, where child nodes are more specific than their respective parent node. A single node may group parameters that are identical and/or similar to each other. For example, not all of the parameters represented by a node are required to be identical. As used herein, a node can be an item. In some embodiments, a single node groups one (or similar) parameters, such as parameters representing the same or similar teaching styles. A separate node can represent a different teaching style. Multiple requestee can be represented in a single node, and the same requestee can be represented over different nodes according to its different parameters. In a single node, for example, related to teaching style, parameters (from associated with different requestees) related to or similar to the teaching style of home learning can be represented in that node. A subsequent timeline window can be used to process different nodes. In a timeline window, a probability is assigned for each parameter for each requestee represented in that node. Different nodes can also be processed in the same timeline window.

In some embodiments, the tree is optimized or trained iteratively based on subsequent requester requests. For example, during optimization of the tree, additional levels and/or child node(s) are created based on the requester's input (NER entities). For example, a new child node can be created that represents a more specific variation of a parameter, where the variation is provided from the requester's request and the variation can be mapped to a requestee's parameter. For example, a child node representing the parameter “at home learning at the computer” can be created as a child node of a node representing the parameter “at home learning”, where one or more requestee parameters represent “at home teaching via the computer”. In some embodiments, searching of the tree can reduce computational power required as not all of the nodes are required to be searched. For example, a parent node can also store data (e.g. name data) directing a search to a particular location of a particular child node based on the request or child node most similar to the request.

Machine learning processor 130 is configured to select one or more nodes (or node groups) and, in a single timeline window, assign weights to each item corresponding to each requestee represented in the node(s) selected. A weight is assigned for each item (e.g., parameter) represented in the node(s) selected for that timeline window. The weight assigned to an item can represent a probability that that item is preferred by the requester based on the requester's request. Each item corresponds to a requestee. A requestee can have one or more items. For example, a teacher can have items corresponding to teaching style, location, availability, language, and/or other items, as well as multiple types of each. For example, a single teacher can have (be associated with) an at-home teaching style as well as online teaching style, each of which can be grouped as separate items in separate nodes. Machine learning processor 130 is configured to assign weights using a weight activation. Other formulas and/or rules can be used. Each of the item(s) (e.g., node(s)) selected for processing in a single timeline window can include one or more identical or similar item(s), each corresponding to a different requestee. Multiple item(s) can be selected for processing in the single timeline window. For example, an item corresponding to an at-home (or similarly grouped) teaching style, an item corresponding to a location in Toronto (or similarly grouped such as areas in the Greater Toronto Area), and an item corresponding to a language of English (or similarly grouped such as English used in different countries) can be selected for processing in a single timeline window. Each item can include parameters corresponding to one or more requestees. The same requestee can have its different parameters for different items processed in the same timeline window, for example. A requestee's parameters are stored in the requestee's profile, according to some embodiments. Below is a tree probability function. This tree structure is configured where every non-leaf node n in level j satisfies the following function for each requestee u:

$${P}^{( j )} ( n \vert u ) = \frac{{max}_{{n}_{c} ∈ \{ n ' s children nodes in level j + 1 \}} {P}^{( j + 1 )} ( {n}_{c} \vert u )}{{α}^{( j )}} ,$$

where P^{(j)}(n|u) is the ground truth probability that user u is interested in n. α^{(j)} is the layer-specific normalization term of level j to ensure that the probability sum in the level equals to 1. The function represents that a parent node's ground truth preference equals to the maximum preference of its children nodes, divided by the normalization term.

The goal is to find k leaf nodes with largest preference probabilities. Where it is the case that each node n's ground truth P^{(j)}(n|u) in the tree, k nodes with largest preference probabilities layer-wise can be retrieved, and only those children nodes of each level's top k need to be explored. In this way, top k leaf nodes can be ultimately retrieved.

Nodes are selected by machine learning processor 130 using the mapping between the requestee's input (e.g., NER entities extracted from same) and parameters (for items) of requestees. For example, given an NER entity value of “home learning” and a mapping of same to “home teaching”, machine learning processor 130 is configured to locate and select an item/node in the tree representing “home teaching”.

For example, in a single timeline window, machine learning processor 130 is configured to process one or more nodes each representing a different item, such as location, teaching style, language, etc., each of which have parameters (values) for each requestee represented in that node. In some embodiments, a single item/node in the tree will not represent all parameters of all requestees corresponding to that item. Instead, multiple nodes can be used to represent same. This enables selection and processing of only a subset of parameters in a timeline window, instead of all parameters corresponding to a single item. For example, if there are ten thousand teachers, their respective teaching styles can be grouped into multiple different nodes based on its similarity in the tree instead of only a single node. Further, a requestee can have multiple parameters given a single item type and each can be stored in a separate node. For example, a teacher can have multiple teaching styles.

In a single timeline window, machine learning processor 130 is configured to assign a weight to each item (i.e., here, parameter) using a weight activation function. Each parameter for an item corresponds to a requestee. Machine learning processor 130 is configured to assign a weighted average for each item corresponding to the requestees in that timeline window. This is performed for each requestee for which an item is processed in that timeline window. Each timeline window outputs an average weight for each item for each requestee.

Machine learning processor 130 is configured to concatenate the weighted average (each representing an item) outputted by each timeline window for requestee. The concatenation is performed for each group of items corresponding to a different requestee. The corresponding node embeddings from which each item was derived in the tree is also concatenated with the corresponding average weight outputted from each timeline window.

In some embodiments, a deep learning model (e.g., neural network) is configured to optimize this weight through training based on data, including: 1) requester's approval/rejection of requestees presented; and/or 2) subsequent requests made by the requester (e.g., the number of times the requester searches for the same or similar type of requestee subsequently), both of which together can be referred to as feedback from the requester. Accordingly, subsequent probabilities outputted for the same request by the same requestee can differ based on improved or a more accurate weight (representing importance) assigned to particular items in the tree based on feedback. For example, node 3 may be assigned a greater weight than node 5 where requesters increasingly and more often select requestees whose items are grouped in node 3 than requestees whose items are grouped in node 5 for the same type of request. As the deep learning model is trained, the deep learning model is configured to modify the weight of each node embedding that is concatenated with the average weights outputted from the timeline windows. For example, if the following concatenated average weights for items for a requestee (as derived from multiple time windows) are as follows: 0.8 (node/item at level 1), 0.5 (node/item at level 3), and 0.9 (node/item at level 2), and based on feedback that the node at level 3's probability was inaccurate and too high, the neural network adjusts the node weight for that node embedding such that node has a lower node weight and will not be given as high significance in determining the final probability for a requestee in subsequent iterations. This node weight is used in subsequent concatenations, where average weights (each corresponding to different nodes) outputted from timeline windows for a requestee are concatenated with the corresponding node embedding data (e.g., node weight) for each corresponding timeline window.

According to some embodiments, layer-wise retrieval rules are used in predictions, such as defined as follows.

Input: Requestee state u, the recommendation tree, the desired item number k, the learnt model
Output: The set of recommended leaf nodes
1 Result set A=Ø, candidate set Q={the root node n1};
2 repeat
2.1 If there are leaf nodes in Q, remove them from Q and insert them into A;
2.2 Calculate (P y\hat{ }(n)=1|n,u) for each remaining node n∈Q;
2.3 Sort nodes in Q in descending order of P (y\hat{ }(n)=1|n,u) and derive the set of top k nodes as I;
2.4 Q={children nodes of n|n∈I};
3 Until |Q|==0;
4 Return the top k items in set A, according to P(y\hat{ }(n)=1|n,u);

Subsequent timeline windows can select a node by traversing the tree, such as by selecting a child node of a parent node processed in the previous timeline window. In the same subsequent timeline window, a child node of another parent node processed in the previous timeline window can be processed. For example, a first timeline window can process nodes each corresponding to one of an at-home teaching style, Toronto location, and English language, and a second timeline window can process nodes each corresponding to one of an at-home online teaching style, downtown Toronto location, and English language from an Australian speaker.

Machine learning processor 130 is configured to apply a final probability function to each concatenation (which represents a requestee). Other functions and/or rules can be used according to some embodiments. The output represents the probability that the requester prefers that requestee. As discussed herein, PReLU & BN and softmax can be applied.

In some embodiments, the system and method are configured to allow for an increasingly accurate result returned for a requester's request, while allowing for reduce computational power. Where there only exist a few nodes in high levels of the tree, thus the discrimination problem is easier. Further, decisions made by high levels nodes refine the candidate set, which may help lower levels nodes make better judgments. For example, not all nodes are required to be searched in the tree, and traversal in the tree may be limited where nodes processed are assigned a suitably high preference probability. Further, simple requests can be matched with requestee(s) by only selecting a parent node or only a few nodes in the tree. Further, as probabilities are assigned to requestees, multiple requestees can be presented to the requester, and the requester's interaction(s) with same (e.g., to approve such as select same) can improve the accuracy of subsequent requestees returned in subsequent searches, through an iterative training process of a neural network for adjusting node weights assigned to nodes in the tree, according to some embodiments.

User interface 110 is configured to present to requester the one or more requestees having a probability value matching a pre-determined threshold or range or formula. For example, requestees determined to have the highest probabilities of being preferred by the requester are listed in order of their probabilities, according to some embodiments.

The disclosed systems, devices, and methods may be embodied in other specific forms without departing from the principles disclosed. Certain adaptations and modifications are possible. Therefore, the presently discussed embodiments are considered to be illustrative and not restrictive and all changes which come within the meaning and range of equivalency of the claims are therefore intended to be embraced therein.

What is claimed is:

1. A computer-implemented method for matching a requester to at least one requestee, comprising:
receiving input representing a request from the requester;
applying a learning top-K tree-based deep model to at least one input and at least one node embedding representing at least one parameter of at least one requestee successively across at least one time window;
wherein, in each time window, at least one parameter processed in the time window is weighted averaged; and wherein each output from each time window for a requestee is concatenated and further concatenated with at least one corresponding node embedding as an input for a probability function, each output representing a probability of a match between a requester parameter derived from the input and a requestee parameter;
determining via the probability function the probability that a requestee is preferred by the requester given the input; and
presenting at least one requestee to the requester for approval based on the probability for the input to match the requestee.

2. The computer-implemented method of claim 1, further comprising using a neural network to optimize at least one node embeddings for based on at least one node based on feedback from the requester response.

3. The computer-implemented method of claim 1, further comprising generating the at least one node embedding based on at least one knowledge repository attribute associated with at least one requestee.

4. The computer-implemented method of claim 1, wherein at least one successively suitable node embedding is selected for each successive time window.

5. The computer-implemented method of claim 4, wherein each successively suitable node embedding is selected based on proximity to a previously selected node embedding in a top-k tree model and a determined probability of the previously selected node embedding to match the input.

6. The computer-implemented method of claim 1, further comprising, for each time window, generating a node embedding from the top-k tree model and determining a weighted average of at least one parameter across each requestee represented in the node embedding.

7. The computer-implemented method of claim 5, further comprising determining the weighted average by applying a weight activation function to each parameter represented in the node embedding, the weight activation function based on a determined value of the requestee.

8. The computer-implemented method of claim 1, further comprising generating the input by applying named entity recognition on the request.

9. The computer-implemented method of claim 1, further comprising optimizing the top-k tree model for determining each probability.

10. The computer-implemented method of claim 1, further comprising generating one or more knowledge repository variations for at least one requestee.

11. The computer-implemented method of claim 1, wherein the input represents the request and additional elements associated with the requestee, the additional elements comprising language, interests, online behavior, historical behavior, availability, or learning style.

12. The computer-implemented method of claim 1, wherein the probability function is defined as
$${P}^{( j )} ( n \vert u ) = \frac{{max}_{{n}_{c} ∈ \{ n ' s children nodes in level j + 1 \}} {P}^{( j + 1 )} ( {n}_{c} \vert u )}{{α}^{( j )}} ,$$
wherein n is a non-leaf node in level j, u is a requestee, P^{(j)}(n|u) is the ground truth probability that user u is interested in n, and α^{(j)} is the layer-specific normalization term of level j to ensure that the probability sum in the level equals to 1.

13. A computer-implemented system for matching a requester to at least one requestee, comprising:
a non-transitory memory storing input representing a request from the requester;
a machine learning processor configured to:
apply a top-k tree model to at least one node group representing at least one parameter of at least one requestee successively across at least one time window;
concatenate each output from each time window for a requestee and at least one node embedding as an input for a probability function; and
determine, via the probability function, each probability for the input to match each requestee; and
a user interface configured to present at least one requestee to the requester for approval based on the probability for the input to match the requestee.

14. The computer-implemented system of claim 13, the machine learning processor further configured to generate the at least one node embedding based on at least one knowledge repository attribute associated with at least one requestee.

15. The computer-implemented system of claim 13, wherein at least one successively suitable node embedding is selected for each successive time window.

16. The computer-implemented system of claim 15, wherein each successively suitable node embedding is selected based on proximity to a previously selected node embedding in the top-k tree model and a determined probability of the previously selected node embedding to match the input.

17. The computer-implemented system of claim 13, the machine learning processor further configured, for each time window, to generate a node embedding from the top-k tree model and determining a weighted average across each requestee represented in the node embedding.

18. The computer-implemented system of claim 17, the machine learning processor further configured to determine the weighted average by applying a weight activation function to each requestee represented in the node embedding, the weight activation function based on a determined value of the requestee.

19. The computer-implemented system of claim 13, further comprising an input processor configured to generate the input by applying named entity recognition on the request.

20. The computer-implemented system of claim 13, the machine learning processor further configured to optimize the top-k tree model for determining each probability.

21. A non-transitory computer-readable medium storing a set of machine-interpretable instructions which, when executed, cause a processor to perform a method for matching a requester to at least one requestee, the method comprising:
receiving input representing a request from the requester;
applying a learning top-k tree-based deep model to at least one input and at least one node embedding representing at least one parameter of at least one requestee successively across at least one time window;
wherein, in each time window, at least one parameter processed in the time window is weighted averaged; and wherein each output from each time window for a requestee is concatenated and further concatenated with at least one corresponding node embedding as an input for a probability function, each output representing a probability that the requester prefers a parameter of the requestee;
determining via the probability function the probability that a requestee is preferred by the requester given the input; and
presenting at least one requestee to the requester for approval based on the probability for the input to match the requestee.
